(19) United States
(12) Patent Application Publication
(10) Pub. No.: US 2009/0231965 A1
(43) Pub. Date: Sep. 17, 2009

(54) Method for setting spherical aberration correction and device using the method

(75) Inventor: Johannes Leopoldus Bakx, Eindhoven (NL)

Correspondence Address: WPAT, PC, 7225 BEVERLY ST., ANNANDALE, VA, 22003, US

(73) Assignee: LITE-ON IT CORPORATION, Taipei City (TW)

(21) Appl. No.: 12/401,793

(22) Filed: Mar. 11, 2009

Related U.S. Application Data
(60) Provisional application No. 61/069,242, filed on Mar. 12, 2008.

(51) Int. Cl. G11B 7/00

(52) U.S. Cl. 369/44.23; G9B/7

(57) ABSTRACT

A method for setting the spherical aberration correction of a scanning beam in a device for scanning an information layer of an optical record carrier. The method comprises the following steps: converging the scanning beam (16) to a focus (17) in the optical record carrier; correcting spherical aberration of the scanning beam; determining a focus error signal (23) during a longitudinal scan of the focus; and determining an optimum setting of the spherical aberration correction that maximizes the peak-peak amplitude (46) of the focus error signal

### FIELD OF THE INVENTION

The invention relates to a method for setting a spherical aberration correction of a scanning beam in a device for scanning an information layer of an optical record carrier. The invention also relates to a scanning device using said method.

### BACKGROUND OF THE INVENTION

In most optical record carriers a transparent cover layer protects the information layer from environmental influences. A scanning beam for reading, erasing or writing data on the information layer traverses the cover layer. The cover layer imparts an amount of spherical aberration to the scanning beam depending on the thickness of the cover layer. The scanning beam must be corrected for this spherical aberration. The correction becomes more critical when the numerical aperture (NA) with which the scanning beam is focussed on the information layer increases. The scanning device for record carriers of the so-called Blu-ray disk (BD) type uses an NA of 0.85, making the correction critically dependent on the thickness of the cover layer, even within the manufacturing tolerance of the thickness of the cover layer of a single type of record carrier. Hence, such a device often requires separate adjustment of the spherical aberration correction for each record carrier being scanned. Adjustment is also necessary if different types of record carrier having different cover layer thicknesses must be scanned. International patent application WO2005/034100 discloses a scanning device in which the spherical aberration correction of the scanning beam can be adjusted by moving a collimator lens within a certain range by means of a stepping motor. When starting a scanning session, the stepping motor is first pre-set by having the motor make a predetermined number of steps pertaining to the record carrier to be scanned, starting from a stop at one of the ends of the range. The relation between the number of steps and the type of record carrier may be stored in the scanning device. After pre-setting, the focus of the scanning beam is positioned on the information layer of the record carrier. The spherical aberration correction is subsequently fine-tuned by scanning the focus over the information layer and leaving the radial servo for the scanning beam in an open loop state. The setting of the position of the collimator lens is optimized by maximizing the peak-peak amplitude of the radial error signal.

The feed-forward pre-setting is sometimes less reliable due to added or missed steps of the stepping motor. The resulting inaccurate positioning of the collimator lens may cause the fine-tuning method to fail, because the spherical aberration correction may be at a setting where there is no radial error signal. The setting must be correct within about 1% of the range for the fine-tuning to be able to start.

Another disadvantage of this method of determining the optimum setting is that it requires correct focussing of the scanning beam on the information layer. If the spherical aberration correction is far from its optimum setting, no radial error signal may be detectable, resulting in a failure to set the spherical aberration correction and, hence, a failure to scan the record carrier.

It is an object of the invention to provide an improved method for setting the spherical aberration correction and a scanning device using the method.

### SUMMARY OF THE INVENTION

The object is achieved by a method for setting the spherical aberration correction of a scanning beam in a device for scanning an information layer of an optical record carrier, comprising the following steps: converging the scanning beam to a focus in the optical record carrier; correcting spherical aberration of the scanning beam; determining a focus error signal during a longitudinal scan of the focus; and determining an optimum setting of the spherical aberration correction that maximizes the peak-peak amplitude of the focus error signal.

The spherical aberration correction may be adjusted by moving an optical component in path of the beam from the laser to the record carrier or by controlling a fixed component that can introduce a variable amount of spherical aberration in the scanning beam, such as a liquid crystal cell.

The longitudinal scan of the focus is made with the focus servo operating in an open loop state. The peak-peak amplitude of the focus error signal depends on the spherical aberration correction, making it a suitable parameter for optimising the spherical aberration correction. Since the peak-peak amplitude of the focus error signal can be determined during a longitudinal scan of the focus, it is not necessary to position the focus accurately on an information layer for optimising the spherical aberration correction, as required in the prior art method.

The focus error signal has a large capture range for the spherical aberration correction, i.e. when the setting of the correction may be relatively far removed from the optimum setting, a focus error signal will still be obtained. The setting is preferably correct within about 20% of the range for the focus error tuning to be able to start.

The focus error signal is very suitable for coarse tuning of the spherical aberration correction. If required, the spherical aberration correction can subsequently be fine-tuned using another signal, e.g. the radial error signal as known from the prior art. The coarse tuning may be preceded by a pre-set step in which the spherical aberration correction is set to a predetermined value. The pre-setting can be less accurate than in the prior art device because of the larger capture range of the focus error signal.

In a three-step process for setting the spherical aberration correction including pre-setting, coarse tuning and fine-tuning, the following characteristics can be distinguished. The pre-setting is a feed-forward step to set the correction in a range where a focus error signal is detectable. The coarse tuning is a feedback optimisation of the focus servo signal, the focus servo operating in open loop, to set the correction in an narrower range that allows proper capture of the focus servo and subsequently of the radial servo. The fine tuning is a feedback optimisation of the read and/or write performance of the device, carried out after closing the focus servo and the radial servo. The invention is not limited to the above three steps and the described implementation and goal. For example, the coarse tuning may result in such an accurate setting of the spherical aberration correction that the fine-tuning step can be omitted. The pre-setting step may be omitted or carried out using a search procedure to locate the range where a focus signal is detectable.

It should be noted that the prior art scanning device uses the radial error signal for fine tuning, which has a relatively narrow capture range compared to the focus error signal. The prior art scanning device requires both pre-setting of the spherical aberration correction and correct focussing on the information layer, before it can tune the correction using the radial error signal.

In a preferred embodiment the method according to the invention comprises the steps of: determining a value of a layer depth parameter for the record carrier to be scanned; and setting the spherical aberration correction in dependence on the value before determining the optimum setting using the focus error signal.

This pre-setting of the spherical aberration correction in dependence on a value of a record-carrier-related parameter is a fast method of bringing the correction close to its optimum value. Moreover, it reduces the chance that at the start of the optimisation of the spherical aberration correction, the setting of the correction is so far from the optimum setting that no focus error signal is obtained. Hence, a method for setting the spherical aberration correction including a pre-setting using the layer depth parameter and a subsequent tuning using the focus error signal optimisation is fast and reliable.

Since the method according to the invention using the focus error signal has a substantially larger capture range than the prior art method using the radial error signal, the chances of failure to tune the spherical aberration correction after pre-setting the correction are much smaller.

The layer depth parameter represents the optical depth of the information layer within the record carrier. The layer depth parameter may be any distinctive parameter and may be coded in any suitable form. It may be the optical depth of the information layer, i.e. the refractive index of the cover layer of the record carrier times the mechanical depth of the information layer below the entrance surface of the record carrier, coded as a unit of length. In a practical method it is directly encoded as a number of steps of a stepping motor that translates the collimator lens. It may also be an indication of a type of the record carrier, which implies a certain value of the layer depth.

The steps of the method to set the spherical aberration correction are preferably carried out at the start of scanning the record carrier. The steps may be preceded by a step of retrieving information from the record carrier to determine its layer depth parameter, e.g. its type.

When only the value of the layer depth parameter for the record carrier to be scanned is available and not for the previously scanned record carrier, the spherical aberration correction must be pre-set with respect to a zero position.

A zero position of a movable collimator lens within a certain range can be defined by an optical sensor. Any positioning of the collimator lens can then be made with reference to this zero position. A disadvantage of this definition of the zero position is the cost of the optical sensor.

Alternatively, a zero position may be defined by a mechanical stop at one of the ends of the range. The collimator can be forced against the stop and any subsequent positioning of the collimator can use the stop as zero position. However, the act of forcing the collimator may cause components to get stuck, thereby making the device unfit for use.

These disadvantages are absent in a method using the layer depth parameter for pre-setting the spherical aberration correction for a second record carrier to be scanned subsequent to termination of scanning of a first record carrier, comprising the steps of: retrieving from a memory a first value of the layer depth parameter pertaining to the first record carrier; determining a second value of the layer depth parameter for the second record carrier; changing the spherical aberration correction from the setting used for the first record carrier in dependence on the difference between the first and second value of the layer depth parameter.

The value of the layer depth parameter for the first record carrier is preferably stored in a memory arranged in the scanning device.

After the termination of the scanning of the first record carrier, the spherical aberration correction will remain at the known setting for that record carrier. This applies in particular the case when the correction involves positioning mechanical parts of the scanning device. The pre-setting for the next record carrier can be determined in relation to the setting of the previous record carrier.

When the value of the layer depth parameter is the same for the latest scanned information layer and for the information layer to be scanned, the pre-setting of the spherical aberration correction need not be changed. This happens if the intended scan is on an information layer having the same value of the layer depth parameter, e.g. of a record carrier of the same type. As a next step coarse tuning may be carried out using the focus error signal and, optionally, a fine-tuning step. When the intended scan is on the same information layer of the same record carrier as the latest scan action, coarse tuning and possibly fine tuning may not be necessary.

When the values of the layer depth parameter are different, the spherical aberration correction need be changed. The difference in value of the parameter, either in type of record carrier or in information layer within a record carrier or in optical depth, allows a feed-forward adjustment of the spherical aberration correction close to the desired setting. When using a stepping motor for the feed-forward adjustment, any inaccuracy in the setting caused by missed or added steps is less likely to affect the optimisation of this setting because of the large capture range of the focus-error signal.

Since this method of pre-setting uses the previous setting of the spherical aberration correction to determine the setting for the next record carrier, no well-defined zero position for the spherical aberration setting is required. Hence, no mechanical stop or photo detector as used in the prior art is necessary.

Although the use of the difference between two values of the layer depth parameter is disclosed in combination with the use of the focus error signal for optimising the spherical aberration correction, the difference can also be used in combination with any other method of subsequently optimising the spherical aberration correction, e.g. using of the radial error signal.

The layer depth parameter may relate to the type of the record carrier, e.g. BD and HD-DVD. When the record carrier has several information layers, one layer depth parameter may pertain to all of the information layers.

Alternatively or in addition, the layer depth parameter may relate to a depth of an information layer in the record carrier. Hence, a record carrier including several information layers may have a layer depth parameter for each of the information layers, the parameter having different values for each of the layers.

The procedure for setting the spherical aberration correction may depend on whether the previous scanning session was terminated normally or abnormally. If the scanning of the first record carrier terminated normally, the spherical aberration correction will still be at the setting suitable for the first record carrier at the time the scanning session of the second record carrier starts. At the start, the spherical aberration this setting can be used to obtain the setting suitable for the second record carrier. If the previous session terminated abnormally, the setting of the spherical aberration correction at the end of the session is unknown and can be anywhere within a range containing the possible predetermined settings for various types of record carrier as stored in the scanning device. In that case the use of the previous setting for obtaining the setting for the second record carrier is often not reliable. The pre-setting for the second record carrier is in such a case preferably obtained by a method comprising the following steps: performing a longitudinal scan of the focus; and setting the spherical aberration correction in dependence on whether a focus error signal from an information layer of the second record carrier is detected during ramping.

The steps used after an abnormal termination form a recovery operation, which can be regarded as a special kind of pre-set step. The operation covers two procedures, one where a focus error signal from an information layer is detected and one where no such focus error signal is detected. A focus error signal is said not to be detected if a so-called S-curve is not observed in the focus error signal when making a longitudinal focus scan with the focus servo operating in open loop.

An abnormal termination of a scanning session can be indicated by a termination indicator at the end of the scanning session. The termination indicator can be a flag, stored in a memory of the scanning device. On starting a subsequent scanning session, the termination indicator can be read to determine the status of the spherical aberration corrector.

If during the recovery operation the focus error signal is detected, the spherical aberration correction for the second record carrier is preferably set by controlling the spherical aberration correction to increase the peak-peak amplitude of the focus error signal.

If the focus error signal is not detected, the setting of the spherical aberration correction is preferably changed in increasing steps in alternate directions until the focus error signal is detected. Once the signal is detected, the spherical aberration correction can be optimised by maximising the peak-peak amplitude of the focus error signal.

The first one of the one or more increasing steps of the spherical aberration correction is preferably smaller than twice the FWHM (full-width-half-maximum) of the bell-curve of the peak-peak focus error signal as a function of the spherical aberration correction. When the step is smaller than twice the FWHM of the bell-curve, a step will never be so large that the spherical aberration correction jumps over a bell-curve and fails to find a desired setting of the correction.

The method according to the invention comprises preferably the step of setting the spherical aberration correction by optimizing jitter of a data signal or the peak-to-peak amplitude of a radial error signal.

After setting the spherical aberration correction using optimisation of the focus error signal, the spherical aberration correction may by be fine tuned by minimising jitter of the data signal or maximizing the radial error signal. Alternative fine-tuning methods use the Viterbi figures-of merit, such as the so-called PRSNR, which is suitable for the HD-DVD type record carrier.

The invention also relates to a device for scanning an information layer of an optical record carrier, comprising a radiation source for generating a scanning beam; an objective system for converging the scanning beam to a focus on the information layer; a detection system for detecting radiation from the record carrier and forming a focus error signal; a correction controller having the focus error signal as input and a correction control signal as output, the correction control signal depending on a peak-peak value of the focus error signal during a longitudinal scan of the focus; and a spherical aberration corrector for imparting spherical aberration to the scanning beam, a setting of the spherical aberration corrector depending on the value of the control signal.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic view of an optical record carrier;

FIG. 2 shows a schematic view of a cross-section of a single-layer record carrier;

FIG. 3 shows a schematic view of a cross-section of a dual-layer record carrier;

FIG. 4 shows an apparatus according to the invention for scanning a record carrier;

FIG. 5a and 5b show a focus error signal for two different settings of the spherical aberration correction;

FIG. 6 shows the peak-peak amplitude as a function of the setting of the spherical aberration corrector; and

FIG. 7 shows range of settings of the spherical aberration corrector.

### DETAILED DESCRIPTION OF THE INVENTION

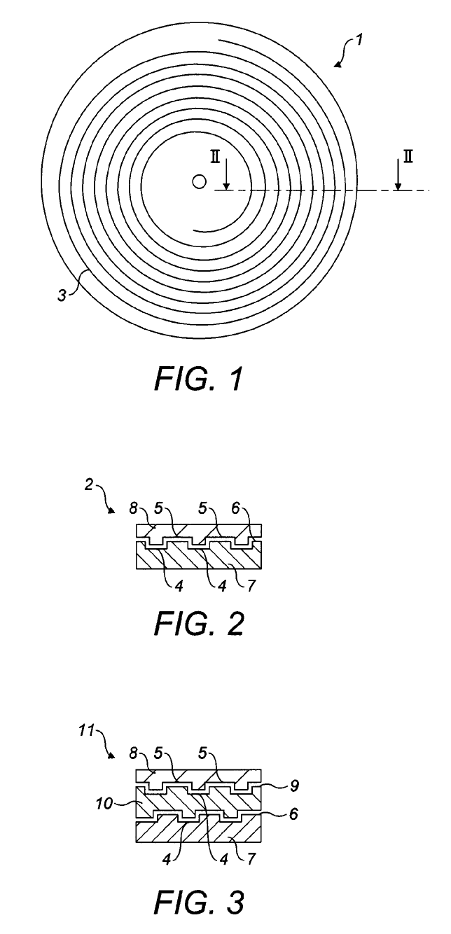

FIG. 1 shows an information layer 1 of an optical record carrier. The record carrier shown is disc shaped. The data on the information layer is arranged in tracks, each forming a 360° turn of a spiral 3. FIG. 2 shows a cross section of the record carrier 2 along the line II of FIG. 1. The record carrier has a single information layer 6. Each track of the information layer has a groove portion 4 and a land portion 5. The dimensions of some elements of the record carrier are exaggerated for illustrative purposes. Data is coded in the land or groove portion in the form of data areas having properties different from the surrounding areas to allow detection of the data areas. The properties may be e.g. reflectivity or magnetization. The data may also be organized in tracks without land and groove portions, the data areas themselves defining the tracks. The information layer 6 is arranged on a transparent cover layer 7, protecting the information layer from environmental influences. The information layer is scanned by an optical scanning beam from the side of the cover layer. In special embodiments of the record carrier the cover layer may be absent. The other side of the information layer is covered by a protective layer 8. Mechanical stability of the record carrier may be provided by the cover layer and/or the protective layer.

FIG. 3 shows a multi-layer record carrier 11 having two information layers 6 and 9, each provided with tracks, possibly in the form of lands and grooves. The two information layers are separated by a transparent spacer layer 10.

The thickness of the cover layer and the spacer layer of a record carrier is usually defined in the standard of that type of record carrier. For example, the thickness of the cover layer for a so-called Blu-ray type record carrier (BD disk) is between 20 and 30 micrometer and the thickness of the spacer layer is 100 micrometer.

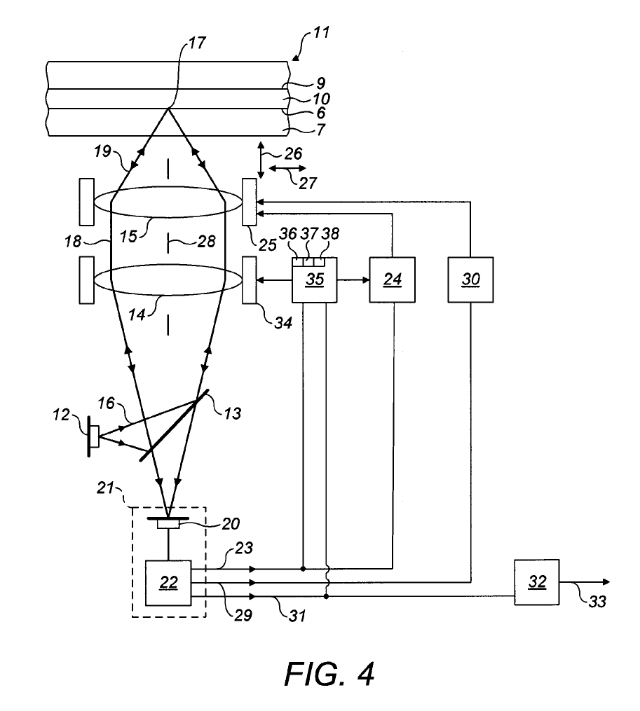

FIG. 4 shows schematically an embodiment of a device for scanning the information layer of a record carrier. The device includes a radiation source 12, which may be a semi-conductor laser. An optical system comprising a beam splitter 13, a collimator lens 14 and an objective system 15 converge a scanning beam 16 generated by the radiation source to a focus 17 on the information layer 6 of the multi-layer record carrier 11. The collimator lens changes the diverging scanning beam from the radiation source in a substantially parallel beam 18. The objective system may be a single lens as shown in the figure, but it may also include several lenses or other components such as a mirror. Radiation reflected by the information layer forms a reflected beam 19, which is collected by the objective system 15, converged by the collimator lens 14 and coupled out of the scanning beam 16 by the beam splitter 13. The reflected beam is incident on a detector 20, forming part of a detection system 21. The detector converts the radiation into electrical detector signals. The detection system also includes a detector signal processor 22. The detector signal processor converts the detector signals to signals for use in the scanning device.

The detector signal processor forms a focus error signal 23, the value of which represents the longitudinal distance between the focus 17 of the scanning beam and the information layer being scanned. The focus error signal may be formed in any known way, e.g. by means of the so-called known astigmatic focus detection. The focus error signal is input to a focus servo controller 24. The focus servo controller controls an actuator 25 that can move the objective system 15 in a longitudinal direction 26 and in a transverse direction 27. A movement of the objective system in the longitudinal direction changes the position of the focus 17 along an optical axis 28 of the objective lens. The focus error signal controls the movement in the longitudinal direction. The detection system, focus servo controller and the actuator together form a focus servo. When the focus servo operates in closed loop, it keeps the focus 17 on the information layer during scanning. Scanning of the information layer is performed by moving the information layer with respect to the focus. For disc-shaped record carriers this is achieved by rotating the record carrier around the axis of the disc.

The detector signal processor 22 also forms a radial error signal 29. The radial error signal represents the transverse distance between the focus 17 and the centre of the track being scanned. The radial error signal may be formed in any known way, e.g. by means of the so-called push-pull method or the so-called DPD method. The radial error signal is input to a radial servo controller 30 that controls the actuator 25 for transverse movement of the focus 17. A movement in the transverse direction, which is the radial direction if a disk-shaped record carrier is used, changes the position of the focus in the plane of the information layer in a direction perpendicular to the tracks. The detection system, radial servo controller and the actuator together form a radial servo. When the radial servo operates in closed loop, it keeps the focus 17 on the centre of the track during scanning of the information layer.

The detector signal processor 22 also forms a data signal 31 representing the data recorded in the information layer. This signal is processed in a read signal processor 32, amongst others for carrying out error correction. An output signal 33 of the processor represents in digital form the data read from the record carrier.

The above described control of the focus position during scanning of the information layer by the focus can be used during reading, erasing and writing data on the information layer. The scanning can be changed from one information layer to another one, e.g. from information layer 6 to 9, by controlling the actuator 25 to make a longitudinal jump to traverse the thickness of the spacer layer 10.

The objective system may impart a fixed amount of spherical aberration to the scanning beam 16 to correct for the spherical aberration incurred by the passage of the scanning beam through the cover layer 7 and, when scanning information layer 9, the spacer layer 10. A variable amount of spherical aberration is imparted to the scanning beam by the collimator lens 14 and an actuator 34 that can move the collimator lens over a certain range along the optical axis 28. By changing the distance between the collimator lens 14 and the radiation source 12, the vergence of the substantially collimated beam 18 formed by the collimator lens, changes. When the objective lens is designed for in incoming collimated beam, than a change in vergence of the incoming beam will cause the objective system to impart a variable amount of spherical aberration to the scanning beam in addition to the fixed amount, the variable amount depending on the vergence of the incoming beam. The variable spherical aberration correction can correct for varying amounts of spherical aberration due to different or varying thickness of the cover layer 7 and, when using a multi-layer record carrier, of the one or more spacer layers 10.

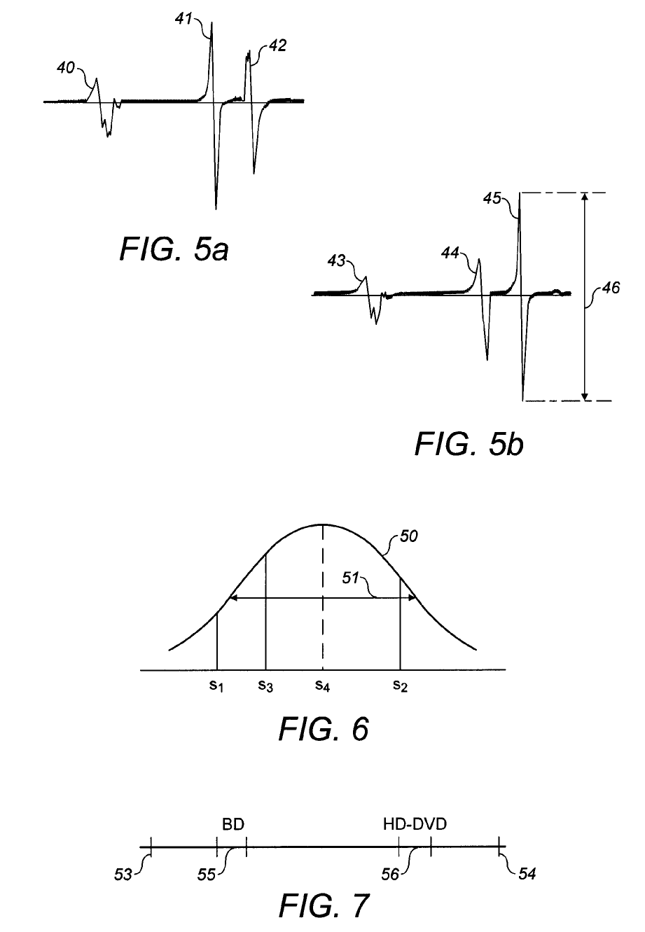

The collimator lens 14 and the actuator 34 form a spherical aberration corrector. Although the spherical aberration corrector in FIG. 5 is based on a longitudinally movable collimator lens, the spherical aberration corrector may also be another component, e.g. a liquid crystal element that can impart a variable change of the wavefront to the scanning beam.

The position of the collimator lens is controlled by the actuator 34, which may be a stepping motor driving a worm or helical pinion and toothed rack combination. A spherical aberration correction controller 35 controls the setting of the actuator in dependence on the focus error signal 23 and, in a special embodiment, in dependence on the data signal 31.

The controllers 24, 30 and 35 may be integrated into a single controller. The detector signal processor 22 and the read signal processor 32 may also be integrated in the single controller.

The use of the focus error signal to determine an optimum setting of the spherical aberration correction will now be described. The influence of the setting of spherical aberration correction on the focus error signal is shown in FIGS. 5a and 5b. The figures show the focus error signal 23 as a function of the longitudinal position of the focus 17. The trace is obtained when the focus servo operates in an open loop mode and the focus servo controller 24 causes the focus to make a longitudinal scan. FIG. 5a shows three S-curves, 40, 41 and 42. The first S-curve 40 is caused by the focus passing through the interface between the air and the cover layer. The second and third S-curve 41, 42 are due to the focus passing the information layer 6 and 9, respectively, as shown in FIG. 4. FIG. 5b shows the focus error signal for the same scanning device and the same record carrier as in FIG. 5a, but with a different setting for the spherical aberration correction. S-curves 43, 44 and 45 correspond to the S-curves 40, 41 and 42.

The value of the peak-peak amplitude of the S-curve, as indicated by the arrow 46 in FIG. 5b, depends on the setting of the spherical aberration correction. The peak-peak amplitude of the S-curve of a particular information layer shows a maximum value when the spherical aberration corrector has the optimum setting for that information layer. The setting of the spherical aberration corrector in FIG. 5a is near optimum for information layer 6, whereas in FIG. 5b it is near optimum for information layer 9.

The correction controller 35 can perform a calibration procedure to optimize the setting of the spherical aberration correction. It will thereto control the actuator 25 through the focus servo controller 24 to make a series of longitudinal scans of the focus, while between scans adjusting the setting of the spherical aberration corrector by controlling the actuator 34. The length of the focus scan should be sufficient to determine the peak-peak amplitude of the S-curve of the information plane to be scanned. The optimum setting of the corrector can be determined from a series of peak-peak amplitudes as a function of the setting.

FIG. 6 shows an example of a trace 50 of the peak-peak amplitude as a function of the setting of the spherical aberration corrector. Based on a series of peak-peak amplitude measurements at different settings of the corrector (s₁, s₂ and s₃ in the figure), the controller can determine the optimum setting (s₄).

The optimum setting derived from the focus error signal may be a coarse setting, which is a near-optimum setting for scanning the information layer. After the course setting, the setting can be fine-tuned by using the data signal 31 from the detection system 21. The correction controller adjusts the setting of the spherical aberration corrector to minimize the jitter in the data signal in a known manner[D1[DV2], e.g. by fitting a parabola through the measured jitter versus spherical aberration curve. Another method of fine-tuning is to maximize the open-loop radial error signal 29, as is known from international patent application WO 2005/034100.

In a special embodiment of the scanning device the spherical aberration corrector is pre-set before the coarse tuning and any fine tuning are carried out. During scanning a first record carrier, the device stores the value of a layer depth parameter pertaining to the first record carrier. The parameter may be an indication of the type of the record carrier. The device can determine the type of record carrier e.g. by comparing the distance between the zero-crossings of the S-curves in a longitudinal focus scan to values stored in a table in a memory of the device. The memory 36 may be part of the correction controller 35, as indicated in FIG. 4. The comparison of the distances between the zero-crossings of the S-curves amounts to comparing thicknesses of cover layers 7 and/or spacer layers 10 of record carriers[D3][DV4]. Alternatively, the distances between the maximum values of the so-called central aperture signal, e.g. the data signal 31, may be used. At the end of the scanning session of a record carrier, indicated by a command to eject the record carrier, the stepping motor of the actuator 34, and thereby the spherical aberration corrector, remains in the position for scanning the information layer of the first record carrier.

On starting the scan of a subsequent, second record carrier, the correction controller determines the type of record carrier, retrieves the type of the first record carrier from the memory, and compares the two. When both types are the same, the coarse tuning of the spherical aberration corrector using the focus error signal will start from the setting for the first record carrier, possibly followed by a fine-tuning step. The coarse tuning and/or the fine tuning can be omitted when the first and second record carrier are the same record carrier.

When the two types of record carrier are not the same, the device may use a look-up table 37, which may be arranged in the correction controller 35, containing types of record carrier and optimum settings of the spherical aberration corrector for each of the types. A comparison of the two types in the table provides the difference in setting required to change the corrector to a setting appropriate for the second record carrier. After this pre-set of the corrector, the coarse tuning and any fine tuning of the spherical aberration correction is carried out.

FIG. 7 shows an example of the range of movement of the collimator lens 14, representing the setting of the spherical aberration correction in a scanning device that can scan both BD and so-called HD-DVD record carriers. A mechanical inner stop 53 and outer stop 54 define the limits of movement. The possible optimum position(s) of the collimator for imparting the amount of spherical aberration for a BD type record carrier are within a sub-range 55, those for a HD-DVD type record carrier in a sub-range 56. The sub-ranges in the figure include the optimum positions for multiple information layers and account for tolerances with respect to the typical values. Hence, sub-range 55 includes the optimum positions for information layers 6 and 9 of the DVD-type record carrier 11.

As an example of the pre-setting method of the spherical aberration correction, the first record carrier scanned is of the HD-DVD type and the second record carrier of the BD type. At the end of the scanning session of the first record carrier, the setting of the spherical aberration correction will be in the sub-range 56. When starting the scan of the second record carrier, the device notes the difference in type of record carrier and, from the lookup table it will obtain the difference in the setting of the spherical aberration corrector. It will move the collimator lens from its position in the sub-range 56 to a position in the sub-range 55. Subsequently, the setting will be coarse tuned using the focus error signal and, possibly, fine-tuned using the data signal.

The device may include a memory 38, as shown in FIG. 4, for storing a flag to cover instances where presetting the spherical aberration corrector requires a different procedure. The flag will be set when a scanning session is concluded normally, i.e. without a scanning error. The flag will not be set if a scanning error has occurred in which the setting of the spherical aberration correction might be lost. After such a scanning error, the setting of the spherical aberration correction need no longer be in the sub-range pertaining to the record carrier that was scanned, but it may be anywhere in or between any sub-ranges. In such a case the preset method using the difference between the record carrier that was scanned and the record carrier to be scanned does not work. Instead, a recovery procedure is launched to bring the setting within the sub-range of the record carrier to be scanned. The recovery procedure avoids the collimator to run into the inner stop or outer stop, where it runs the risk of getting jammed. First a longitudinal focus scan is made. When a focus error signal is detected, the above described procedure will be used to maximize the peak-peak amplitude of the S-curve pertaining to the information layer to be scanned. When no focus error signal is detected, the setting must be changed until an S-curve is detected, thereby avoiding to run into one of the stops. Thereto the setting is changed in steps increasing in size and alternating in direction. For example, the setting is changed by a step of size D in a first, arbitrary direction, a longitudinal focus scan is made, and the presence of an S-curve is monitored. If S-curves are detected, the peak-peak amplitude of the relevant S-curve is optimized using the above described method. If no S-curve is detected, the setting is changed by a step 2D in the opposite direction and again the presence of S-curves is monitored. The procedure is repeating with steps of 3D, 4D, etc. in alternate directions until S-curves are detected and the setting can be optimized using the above described coarse tuning and fine tuning.

The step size D is preferably smaller than twice the FWHM 51 of the curve 50 shown in FIG. 6 to avoid that a step will be so large that the spherical aberration correction jumps over a curve 50 and fails to find a desired setting of the correction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for setting the spherical aberration correction of a scanning beam in a device for scanning an information layer of an optical record carrier, comprising the following steps:
converging the scanning beam to a focus in the optical record carrier;
correcting spherical aberration of the scanning beam;
determining a focus error signal during a longitudinal scan of the focus; and
determining an optimum setting of the spherical aberration correction that maximizes the peak-peak amplitude of the focus error signal.

2. A method according to claim 1, comprising the steps of:
determining a value of a layer depth parameter for the record carrier to be scanned; and
setting the spherical aberration correction in dependence on the value before determining the optimum setting according to claim 1.

3. A method according to claim 2 for setting the spherical aberration correction for a second record carrier to be scanned subsequent to termination of scanning of a first record carrier, comprising the steps of:
retrieving from a memory a first value of the layer depth parameter pertaining to the first record carrier;
determining a second value of the layer depth parameter for the second record carrier;
changing the spherical aberration correction from the setting used for the first record carrier in dependence on the difference between the first and second value of the layer depth parameter.

4. A method according to claim 2 or 3, wherein the layer depth parameter relates to the record carrier type.

5. Method according to claim 2, 3 or 4, wherein the layer depth parameter relates to a depth of an information layer in the record carrier.

6. A method according to claim 1 for setting the spherical aberration correction for a second record carrier to be scanned subsequent to an abnormal termination of scanning of a first record carrier, comprising the following steps:
performing a longitudinal scan of the focus; and
setting the spherical aberration correction in dependence on whether a focus error signal from an information layer of the second record carrier is detected during ramping.

7. A method according to claim 6 for setting the spherical aberration correction for the second record carrier where the focus error signal is detected, comprising the step of:
controlling the spherical aberration correction to increase the peak-to-peak amplitude of the focus error signal.

8. A method according to claim 6 for setting the spherical aberration correction for the second record carrier where the focus error signal is not detected, comprising the steps of:
changing the spherical aberration correction in increasing steps in alternate directions until the focus error signal is detected.

9. A method according to claim 8, wherein the first step of the spherical aberration correction is smaller than twice the FWHM of the bell-curve of the peak-to-peak focus error signal as a function of the spherical aberration correction.

10. A method according to claim 1, 2 or 6, comprising the step of setting the spherical aberration correction by optimizing jitter of a data signal or the peak-to-peak amplitude of a radial error signal.

11. A device for scanning an information layer of an optical record carrier, comprising
a radiation source for generating a scanning beam;
an objective system for converging the scanning beam to a focus on the information layer;
a detection system for detecting radiation from the record carrier and forming a focus error signal;
a correction controller having the focus error signal as input and a correction control signal as output, the correction control signal depending on a peak-peak value of the focus error signal during a longitudinal scan of the focus; and
a spherical aberration corrector for imparting spherical aberration to the scanning beam, a setting of the spherical aberration corrector depending on the value of the control signal.

12. A device according to claim 11, wherein the correction controller is arranged for determining the setting of the spherical aberration corrector that maximises the peak-peak value of the focus error signal.

13. A device according to claim 1 1, including an arrangement for determining the value of the layer depth parameter for a record carrier being scanned.

14. A device according to claim 13, wherein the correction controller includes an input for the layer depth parameter for setting the corrector.

15. A device according to claim 13, including a memory for holding a value of the layer depth parameter.

16. A device according to claim 15, wherein the correction controller is arranged to obtain a first value of the layer depth parameter pertaining to the latest scanned record carrier from the memory, to compare the first value with a second value of the layer depth parameter pertaining to the record carrier being currently scanned and to set the spherical aberration corrector in dependence on the difference between the first and second value.

17. A device according to claim 11, wherein the correction controller is arranged to scan the spherical aberration correction in increasing steps in alternate directions.

18. A device according to claim 11, wherein the correction controller includes an input for a data signal or a radial error signal for setting the spherical aberration corrector.
